(19) United States
(12) Patent Application Publication
(10) Pub. No.: US 2018/0370712 A1
(43) Pub. Date: Dec. 27, 2018

(54) MICROWAVE COMPATIBLE CONTAINER AND METHOD OF USE TO HEAT FOOD

(71) Applicant: Shlomo Rush, Sherman Oaks, CA (US)

(72) Inventor: Shlomo Rush, Sherman Oaks, CA (US)

(21) Appl. No.: 16/017,117

(22) Filed: Jun. 25, 2018

Related U.S. Application Data
(60) Provisional application No. 62/525,634, filed on Jun. 27, 2017.

(51) Int. Cl. B65D 81/34; A47J 36/02

(52) U.S. Cl. CPC B65D 81/3453; B65D 2581/3437; A47J 36/027

(57) ABSTRACT

A microwave compatible container for heating food can comprise a bottom wall, outer and inner walls extending from the bottom wall, and a removable top. The outer wall can have an exterior surface and an interior surface. The inner wall can have an exterior facing surface and an interior facing surface. The interior facing surface of the inner wall and the bottom wall can define an inner compartment of the container. Further, the exterior facing surface of the inner wall, the interior surface of the outer wall, and the bottom wall can define an outer compartment that surrounds the inner compartment. The removable top can be sealingly engaged with the outer wall and/or the inner wall in a closed configuration such that the inner compartment is sealed from the outer compartment. Food can be placed within the inner compartment and water can placed in the outer compartment during microwaving.

### CROSS-REFERENCE TO RELATED APPLICATIONS

This application claims the benefit of U.S. Provisional Application No. 62/525,634, filed on Jun. 27, 2017. The entire disclosure of the above application is incorporated herein by reference.

### FIELD

The present disclosure relates to food containers and, more specifically, to a microwave compatible container and associated method of use for heating food.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Microwave ovens have been in household use for decades. Microwave ovens generally use radio waves at approximately 2.45 gigahertz (GHz), where the waves have wavelengths of approximately micron lengths (thus, “microwaves”), to agitate water molecules in food. As the water molecules are excited by the radio waves, the water begins to vibrate and generate heat. Because the water molecules in the food are vibrating and generating heat at the same time, food may cook in microwave ovens faster than food cooked in a conventional oven where heat slowly travels from the outside surface of the food inward. Additionally, many consumers use microwave ovens for reheating previously cooked food. For many foods, microwave reheating over-excites the water molecules and dries out the food. Examples of food that may not reheat well are dough-based foods such as breads, pizza, sandwiches, hamburgers or cheeseburgers in a bun, and french fried potatoes.

### SUMMARY

In various embodiments of the present disclosure, a method of heating food with a microwave is disclosed. The method can include providing a microwave compatible container for heating food. The container can comprise a bottom wall, outer and inner walls extending from the bottom wall, and a removable top. The outer wall can have an exterior surface and an interior surface. The inner wall can have an exterior facing surface and an interior facing surface. The interior facing surface of the inner wall and the bottom wall can define an inner compartment of the container. Further, the exterior facing surface of the inner wall, the interior surface of the outer wall, and the bottom wall can define an outer compartment that surrounds the inner compartment. The removable top can be sealingly engaged with the outer wall and the inner wall in a closed configuration such that the inner compartment is sealed from the outer compartment.

The method can also include placing food within the inner compartment and at least partially filling the outer compartment with water or another liquid. The method can additionally include sealingly engaging the removable top with the outer wall and the inner wall in the closed configuration such that the food and the water or other liquid are sealed within the inner compartment and outer compartment, respectively. A microwave can be utilized to heat the food when the food and the water or other liquid are sealed within the inner compartment and outer compartment, respectively.

In other aspects, the present disclosure relates to a microwave compatible container for heating food. The container can comprise a bottom wall, outer and inner walls extending from the bottom wall, and a removable top. The outer wall can have an exterior surface and an interior surface. The inner wall can have an exterior facing surface and an interior facing surface. The interior facing surface of the inner wall and the bottom wall can define an inner compartment of the container. Further, the exterior facing surface of the inner wall, the interior surface of the outer wall, and the bottom wall can define an outer compartment that surrounds the inner compartment. The removable top can be sealingly engaged with the outer wall and the inner wall in a closed configuration such that the inner compartment is sealed from the outer compartment.

In additional or alternative aspects, the present disclosure relates to a microwave compatible container for heating food. The container can comprise a bottom wall, outer and inner walls extending from the bottom wall, and a removable top. The outer wall can have an exterior surface and an interior surface. The inner wall can have an exterior facing surface and an interior facing surface. The interior facing surface of the inner wall and the bottom wall can define an inner compartment of the container. Further, the exterior facing surface of the inner wall, the interior surface of the outer wall, and the bottom wall can define an outer compartment that surrounds the inner compartment. The removable top can be sealingly engaged with the outer wall in a closed configuration such that the inner and outer compartments are sealed, e.g. from the ambient environment.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of an example microwave compatible container according to some implementations of the present disclosure;

FIG. 2 is a side view of the example microwave compatible container of FIG. 1;

FIG. 3 is a sectional view of the microwave compatible container of FIG. 1; and

FIG. 4 is an example flow diagram of a method of heating food with a microwave according to some implementations of the present disclosure.

### DETAILED DESCRIPTION

As previously discussed, microwave ovens are frequently used for cooking and reheating food. There are many microwave cooking gadgets available on the market for consumers. For example only, there are specialty microwave pasta cookers, bacon trays or racks, and even microwave egg containers. The microwaves that agitate the water molecules may pass through many plastics, glass, and ceramics without agitating any of the molecules of such materials. As such, plastic and glass containers may not heat up when used in microwave ovens. Metals reflect microwaves and, therefore, metal containers may not be safe to use in microwave ovens. For this reason, most microwave cooking gadgets are made of a plastic, glass, and/or ceramic material, which can be identified as “microwave safe.”

While utilizing a microwave oven is a quick and convenient way to cook and reheat food, there may also be drawbacks associated with utilizing a microwave to cook/reheat certain foods. For example only, microwave reheating may over-excite the water molecules and dry out certain foods, such as breads, pizza, and sandwiches. In other foods, microwave reheating may cause the food to become soggy. It would be desirable to provide a microwave cooking container that addresses some or all of these drawbacks and provides for improved cooking or reheating of food when utilizing a microwave oven.

Accordingly, a microwave compatible cooking/reheating container and method of use are presented. The container includes two compartments: an inner compartment and an outer compartment. Food is placed within the inner compartment and water or another liquid is placed in the outer compartment. A removable top is secured to the container. The removable top may seal the container from the ambient environment. Further, in some aspects, the removable top may seal the inner compartment from the outer compartment such that the food compartment is not in communication with the water/liquid compartment. In this manner, the steam, moisture, etc. generated by heating the water/liquid will not enter into the food compartment during reheating. In other aspects, the removable top may seal the container from the ambient environment but not seal the inner compartment from the outer compartment. In this manner, the steam, moisture, etc. generated by heating the water/liquid will be free to enter the food compartment during reheating.

The microwave container may additionally or alternatively include a raised surface in the inner (food) compartment such that food placed within the inner compartment will not rest directly on the bottom wall of the container. In this manner, air may circulate under the food during the heating process, which may provide a more even distribution of heat to the food. Additionally, water or another liquid may be placed in the inner compartment as well as the outer compartment such that moisture, steam, etc. from the liquid in the inner compartment may contact the food. The raised surface can be a tray or a plurality of projections extending upwardly from the bottom wall of the container.

By placing water or another liquid in the outer compartment and food within the inner compartment, the disclosed microwave container permits for an improved method of cooking and reheating food. For example only, the water in the outer compartment may absorb some of the microwave energy generated by the microwave and, thereby, avoid the over-excitement of the water molecules in the food. This permits a more even cooking or reheating of the food while also inhibiting the drying out of the food. Further advantages of the container may be readily apparent.

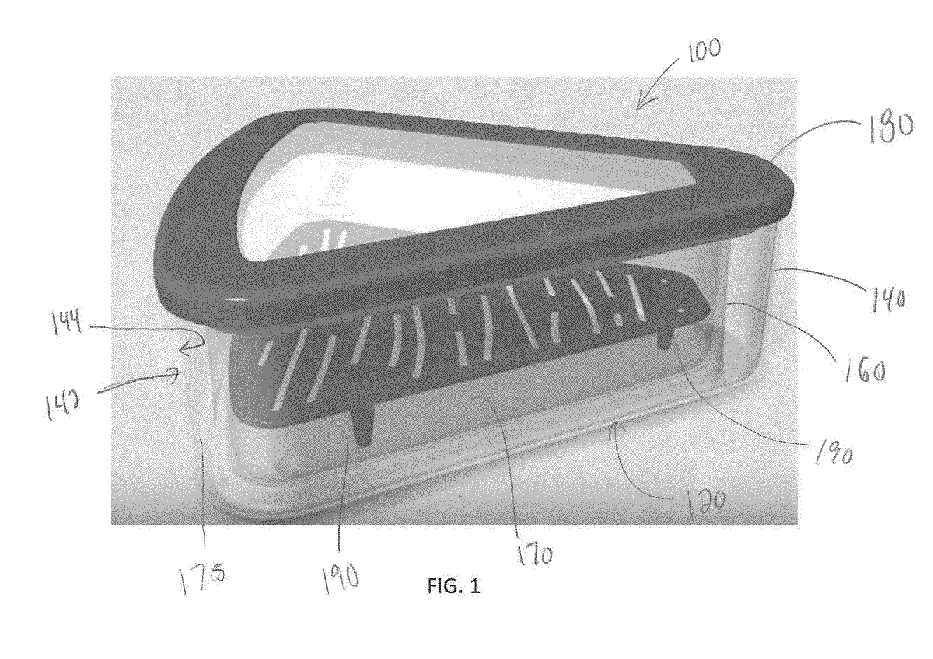

Referring now to FIG. 1, an example microwave container 100 according to some implementations of the present disclosure is illustrated. The illustrated microwave container 100 is shaped like a triangular prism (e.g., to mimic the traditional shape of a slice of pizza) but it should be appreciated that other shapes are within the scope of the present disclosure. As briefly mentioned above, the container 100 may be formed of any microwave compatible material, including but not limited to a plastic, glass, ceramic, paper, and or cardboard material.

The container 100 can include a bottom wall 120, an outer wall 140, an inner wall 160, and a removable top 180. The outer wall 140 can extend upwardly from the bottom wall 120 and have an exterior surface 142 and an interior surface 144. The exterior surface 142 can comprise the outside surface of the container 100, and the interior surface 144 can comprise the primary interior surface of the container 100. Similarly, the inner wall 160 can have an exterior facing surface 162 and an interior facing surface 164.

The bottom wall 120, outer wall 40, and the inner wall 160 can cooperate to define at least two chambers or compartments of the container 100. In the illustrated example, the interior facing surface 164 of the inner wall 160 and the bottom wall 120 cooperate to define an inner compartment 170. Further, the exterior facing surface 162 of the inner wall 160, the interior surface 144 of the outer wall 140, and the bottom wall 120 cooperate to define an outer compartment 175 that surrounds the inner compartment 170.

In the illustrated example of FIG. 1, the removable top 180 is shown in the closed configuration wherein the removable top 180 is coupled with the other portions of the container 100. The removable top 180 can be sealingly engaged with the outer wall 140 such that the inner compartment 170 and the outer compartment 175 are sealed from the ambient environment. Additionally or alternatively, in some implementations, and as more fully described below, the removable top 180 can be sealingly engaged with the inner wall 160.

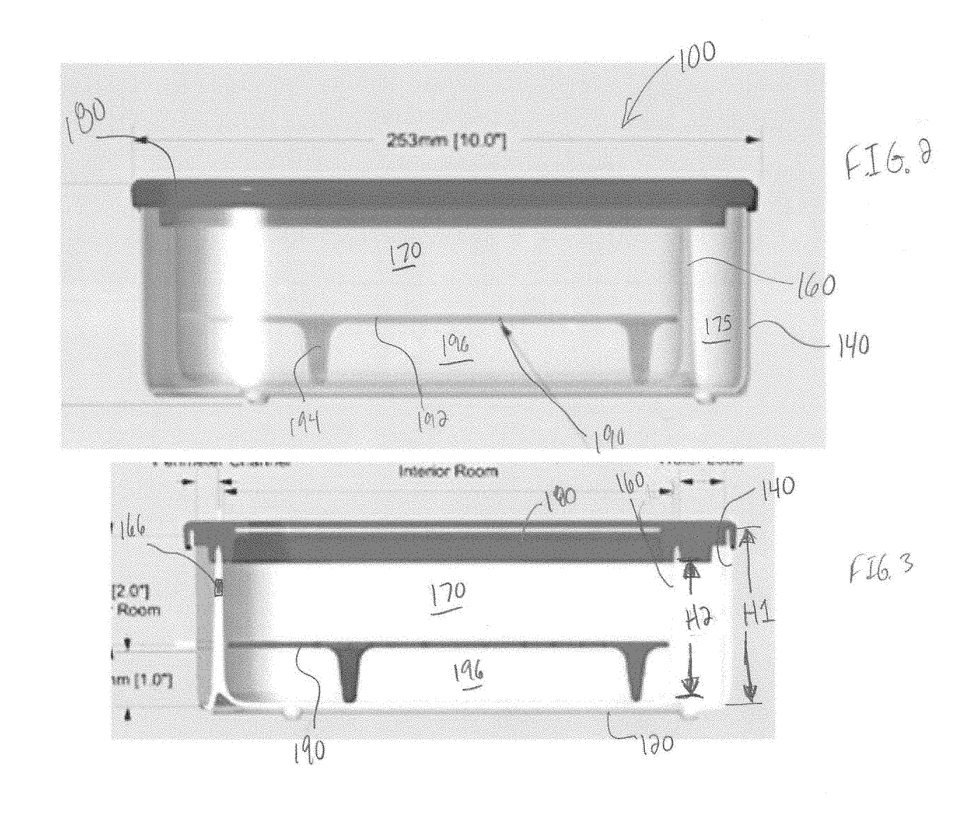

With further reference to FIG. 2, the removable top 180 can sealingly engaged with both the outer wall 140 and the inner wall 160 such that the inner compartment 170 is sealed from the outer compartment 175, and both the inner and outer compartments 170, 175 are sealed from the ambient environment. In this example, the container 100 can also provide the additional functionality of being able to store food in a chilled state for a period of time. For example only, a user may at least partially fill the outer compartment 175 with water or other liquid and then freeze the water/liquid in a freezer. Food may be placed within the inner compartment 170 and the ice/frozen liquid can provide a cooling function on the food. In this manner, the container 100 can be a food cooler as well as a heating container.

In some implementations, the container 100 can further include a raised surface 190 that is arranged the bottom wall 120 within the inner compartment 170. In the illustrated example of FIGS. 1 and 2, the raised surface 190 comprises a tray 192 that includes one or more legs 194. The tray 192 can be placed within the inner compartment 170 with its legs 194 resting on the bottom wall 120. In this manner, the bottom wall 120 and the tray 194 can define a plenum 196 through which air within the inner compartment 170 may flow/circulate. Food to be heated in the microwave can be placed on the raised surface 190, thereby allowing air to be above and below the food to be heated.

It should be appreciated that, although the raised surface 190 is illustrated as the tray 192, the raised surface 190 may take other forms. For example only, the raised surface 190 may comprise a plurality of projections (not shown) extending upwardly from the bottom wall 120. Food to be heated in the microwave can be placed on the raised surface 190/plurality of projections and air can flow both above and below the food during heating. The plurality of projections can have various shapes, such as a pyramidal shape, a hemispherical shape, a columnar shape, a line, a stripe, or a combination thereof.

In addition to providing for air circulation below the food to be heated, the raised surface 190 may also permit water or another liquid to be placed in the inner compartment 170 without contacting the food to be heated. For example only, a user may partially fill the inner compartment 170 with water or another liquid below a level of the raised surface 190. In this manner, the moisture, steam, etc. released by the water/liquid during heating can rise and come into contact with the bottom of the food, e.g., to steam the food during heating.

With further reference to FIG. 3, the outer wall 140 and inner wall 160 may have the same height or be of different heights, depending on the desired performance of the container 100. In the illustrated example of FIG. 3, the outer wall 140 can extend from the bottom wall 120 to a first height H1 and the inner wall 160 can extend from the bottom wall 120 to a second height H2 shorter than the first height H1. In this example, the removable top 180 is shown as sealingly engaged with both the outer wall 140 and the inner wall 160, as described above. In an alternative configuration, the removable top 180 is not sealingly engaged with the inner wall 160, due to the height difference between H1 and H2, such that the inner and outer compartments 170, 175 are fluidly coupled in the closed configuration. Alternatively or additionally, the inner wall 160 may define one or more apertures 166 (FIG. 3) through which the inner and outer compartments 170, 175 can be fluidly coupled, even if the removable top is sealingly engaged with both the outer wall 140 and the inner wall 160.

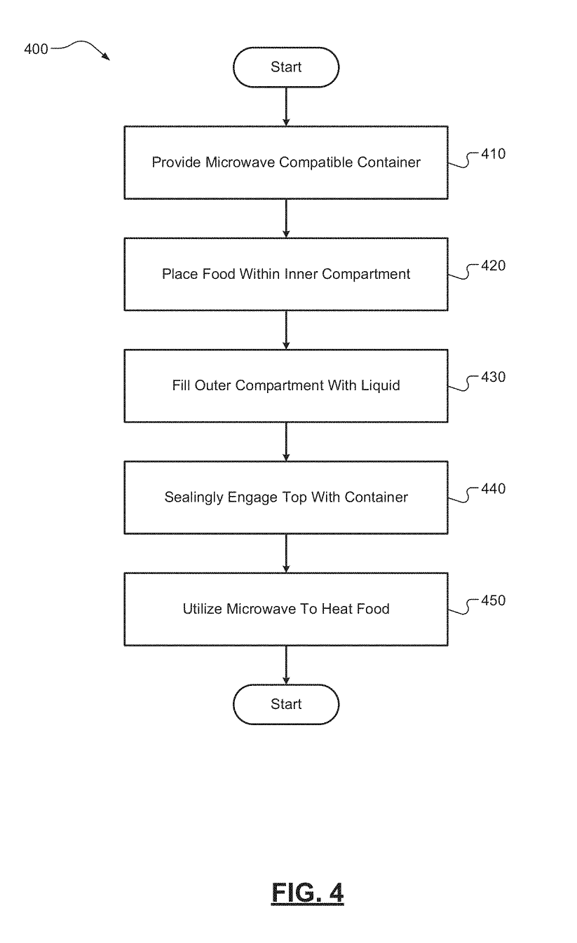

With reference to FIG. 4, an example method 400 of heating food with a microwave is illustrated. At 410, a microwave compatible container, such as container 100, can be provided. The container 100 can take any of the forms described above and include an inner compartment 170, an outer compartment 175, and a removable top 180. A food item to be heated can be placed (420) within the inner compartment 170 and the outer compartment 175 can be at least partially filled (430) with water or another liquid. At 440, the removable top 180 can be sealingly engaged with the container 100 in the closed configuration, such as with the outer wall 140 and/or the inner wall 160 as described above. The container 100, with the food and water or other liquid inside, can be placed within a microwave, which is utilized (450) to heat the food. As described above, the food and the water or other liquid can be sealed within the inner compartment 170 and outer compartment 175, respectively.

The disclosed container 100 and method 400 have been found to be effective to heat and/or reheat many different types of food without drying out the food, rendering the food moist or soggy, or otherwise ruining the appropriate texture (crispiness, crunch, softness or hardness, etc.) of the food. Examples of food that have shown exceptional heating/reheating performance include, but are not limited to, dough-based foods such as pizza, sandwiches, and breads, hamburgers or cheeseburgers (in a bun) with french fried potatoes, vegetables, and fish and other proteins.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of heating food with a microwave, comprising:
providing a microwave compatible container for heating food, the container comprising:
a bottom wall,
an outer wall extending from the bottom wall and having an exterior surface and an interior surface,
an inner wall extending from the bottom wall and having an exterior facing surface and an interior facing surface, wherein (i) the interior facing surface of the inner wall and the bottom wall define an inner compartment, and (ii) the exterior facing surface of the inner wall, the interior surface of the outer wall, and the bottom wall define an outer compartment that surrounds the inner compartment, and
a removable top for sealingly engaging with the outer wall and the inner wall in a closed configuration such that the inner compartment is sealed from the outer compartment;
placing food within the inner compartment;
at least partially filling the outer compartment with water or another liquid;
sealingly engaging the removable top with the outer wall and the inner wall in the closed configuration such that the food and the water or other liquid are sealed within the inner compartment and outer compartment, respectively; and
utilizing a microwave to heat the food when the food and the water or other liquid are sealed within the inner compartment and outer compartment, respectively.

2. The method of claim 1, wherein the container further comprises a raised surface arranged above the bottom wall within the inner compartment.

3. The method of claim 2, wherein the raised surface comprises a plurality of projections extending upwardly from the bottom wall.

4. The method of claim 3, wherein the food is placed on the raised surface and wherein air may flow between the food and the bottom wall.

5. The method of claim 3, wherein each of the plurality of projections comprises a pyramidal shape, a hemispherical shape, a columnar shape, a line, a stripe, or a combination thereof.

6. The method of claim 2, wherein the raised surface comprises a tray arranged above the bottom wall such that air may flow between the tray and the bottom wall, wherein the food is placed on the tray.

7. The method of claim 2, further comprising partially filling the inner compartment with water or another liquid below a level of the raised surface and placing the food on the raised surface.

8. A microwave compatible container for heating food, the container comprising:
a bottom wall;
an outer wall extending from the bottom wall and having an exterior surface and an interior surface;
an inner wall extending from the bottom wall and having an exterior facing surface and an interior facing surface, wherein (i) the interior facing surface of the inner wall and the bottom wall define an inner compartment, and (ii) the exterior facing surface of the inner wall, the interior surface of the outer wall, and the bottom wall define an outer compartment that surrounds the inner compartment; and
a removable top for sealingly engaging with the outer wall and the inner wall in a closed configuration such that the inner compartment is sealed from the outer compartment.

9. The container of claim 8, further comprising a raised surface arranged above the bottom wall within the inner compartment.

10. The container of claim 9, wherein the raised surface comprises a plurality of projections extending upwardly from the bottom wall.

11. The container of claim 10, wherein, when food is placed on the raised surface, air may flow between the food and the bottom wall.

12. The container of claim 10, wherein each of the plurality of projections comprises a pyramidal shape, a hemispherical shape, a columnar shape, a line, a stripe, or a combination thereof.

13. The container of claim 9, wherein the raised surface comprises a tray arranged above the bottom wall such that air may flow between the tray and the bottom wall and food is placed on the tray.

14. A microwave compatible container for heating food, the container comprising:
a bottom wall;
an outer wall extending from the bottom wall and having an exterior surface and an interior surface;
an inner wall extending from the bottom wall and having an exterior facing surface and an interior facing surface, wherein (i) the interior facing surface of the inner wall and the bottom wall define an inner compartment, and (ii) the exterior facing surface of the inner wall, the interior surface of the outer wall, and the bottom wall define an outer compartment that surrounds the inner compartment; and
a removable top for sealingly engaging with the outer wall in a closed configuration such that the inner and outer compartments are sealed.

15. The container of claim 14, further comprising a raised surface arranged above the bottom wall within the inner compartment.

16. The container of claim 15, wherein the raised surface comprises a plurality of projections extending upwardly from the bottom wall.

17. The container of claim 16, wherein each of the plurality of projections comprises a pyramidal shape, a hemispherical shape, a columnar shape, a line, a stripe, or a combination thereof.

18. The container of claim 15, wherein the raised surface comprises a tray arranged above the bottom wall such that air may flow between the tray and the bottom wall and food is placed on the tray.

19. The container of claim 14, wherein the outer wall extends from the bottom wall to a first height and the inner wall extends from the bottom wall to a second height shorter than the first height such that the inner and outer compartments are fluidly coupled in the closed configuration.

20. The container of claim 14, wherein the inner wall defines a plurality of apertures such that the inner and outer compartments are fluidly coupled in the closed configuration.
